(19) United States
(12) Patent Application Publication
(10) Pub. No.: US 2011/0037581 A1
(43) Pub. Date: Feb. 17, 2011

(54) User Definable Vehicle System Sounds

(75) Inventors: Nello Joseph Santori, Canton, MI (US); Joseph N. Ross, Ypsilanti, MI (US)

Correspondence Address: BROOKS KUSHMAN P.C./FGTL, 1000 TOWN CENTER, 22ND FLOOR, SOUTHFIELD, MI, 48075-1238, US

(73) Assignee: FORD GLOBAL TECHNOLOGIES, LLC, Dearborn, MI (US)

(21) Appl. No.: 12/539,063

(22) Filed: Aug. 11, 2009

(51) Int. Cl. B60Q 1/00

(52) U.S. Cl. 340/438

(57) ABSTRACT

A method of vehicle system sound playback includes uploading a user-selected sound to be associated with a vehicle system to a persistent memory within a vehicle. The method includes associating the sound with the vehicle system based on a pre-selection made by the user. Further, the method includes detecting the activation of the vehicle system and playing the sound associated with the vehicle system through a vehicle audio system.

### BACKGROUND

1. Technical Field

Vehicle computing systems have advanced to a point where integrated microprocessors can access and control numerous vehicle devices and systems. For example, an integrated microprocessor, such as one used in the FORD SYNC system, can access a vehicle CAN bus to integrate and report vehicle system information to a user. The computing system can also access features like an onboard GPS, the vehicle audio system, and many other vehicle components. This range of access allows the driver to have a whole new driving experience.

2. Background Art

As other advances in automotive technology, vehicle acoustics have received a great deal of focus, especially when it comes to dampening vehicle sounds in the cabin. Engines run more quietly and advanced dampening systems help silence the noise of the engines within the cabin. Some drivers, however, may long for a return to the days of roaring engines and rumbling tailpipes.

Drivers now travel in a technologically advanced environment, which has progressed to the level that may allow drivers to actually recreate a “simpler” vehicle environment while not foregoing any of the modern conveniences provided by these more sophisticated vehicle computing and sound control systems.

### SUMMARY

In one illustrative embodiment, a method of vehicle system sound playback includes uploading at least one user-selected sound to be associated with at least one vehicle system to a persistent memory within a vehicle. The sound could be selected, for example, using a web-based interface, and thereby configured as well if needed.

In this embodiment, the method also includes associating sound with the vehicle system based on a pre-selection made by the user. For example, the user could choose to associate the sound with a door opening. Next, the exemplary method includes detecting the activation of the at least one vehicle system and playing the at least one sound associated with the vehicle system through a vehicle audio system. For example, if a user associated the sound of a screen door with an automotive door, perhaps to make a humorous comment on the old nature of the car, when the door was opened, the sound of a screen door creaking open would be played through the vehicle audio system.

In another illustrative embodiment, a computer readable storage medium stores a plurality of instructions that, when executed, cause a vehicle based computing system to perform a method including accessing a vehicle system bus to read signals passing therethrough. These signals can indicate the activation or state-change of various vehicle systems.

The illustrative method also includes detecting a signal indicating a change in a vehicle system state, wherein a user-definable sound has been pre-associated with the vehicle system and stored in a persistent memory within a vehicle. For example, a virtual engine sound (or a recorded version of an actual engine) could be stored to be played back when an engine/transmission state changes.

Finally, this illustrative embodiment includes playing the user-definable sound through the vehicle's audio system.

In another illustrative embodiment, a method for masking an engine sound with a virtual sound includes uploading a user-selected engine sound to a persistent memory within a vehicle.

This method further includes detecting at least an acceleration or deceleration of the vehicle and, based at least in part on the detected acceleration or deceleration, playing back the user-selected engine sound over an audio system of the vehicle.

### BRIEF DESCRIPTION OF THE DRAWINGS

FIG. 1 is an illustrative exemplary vehicle computing system usable to implement the illustrative embodiments;

FIG. 2 is an illustrative process for acquiring and configuring vehicle system sounds;

FIG. 3 is an exemplary process for applying a vehicle system sound to a vehicle system access;

FIG. 4 is an exemplary process for automatically applying a vehicle sound configuration based on user device detection; and

FIGS. 5a & 5b show an illustrative example of a process for applying a virtual engine sound to a vehicle engine.

### DETAILED DESCRIPTION

The present invention is described herein in the context of particular exemplary illustrative embodiments. However, it will be recognized by those of ordinary skill that modification, extensions and changes to the disclosed exemplary illustrative embodiments may be made without departing from the true scope and spirit of the instant invention. In short, the following descriptions are provided by way of example only, and the present invention is not limited to the particular illustrative embodiments disclosed herein.

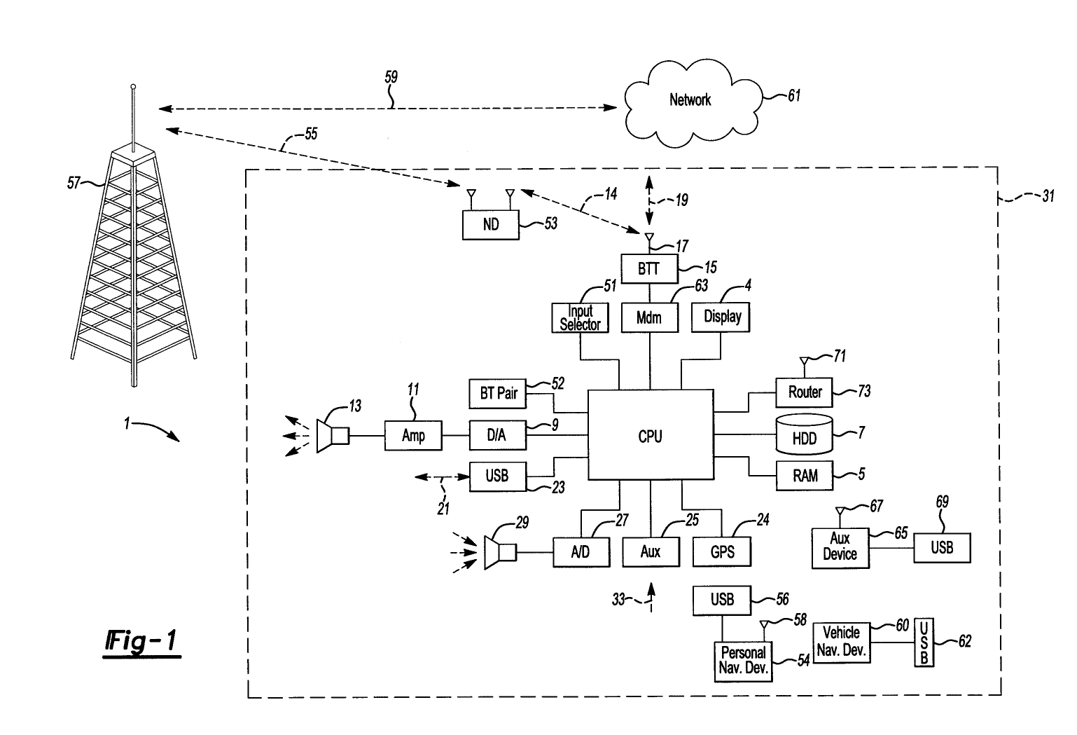

FIG. 1 illustrates an example block topology for a vehicle based computing system 1 for a vehicle 31. A vehicle enabled with a vehicle-based computing system may contain a visual front end interface 4 located in the vehicle. The user may also be able to interact with the interface if it is provided, for example, with a touch sensitive screen. In another illustrative embodiment, the interaction occurs through, button presses, audible speech and speech synthesis.

In the illustrative embodiment 1 shown in FIG. 1, a processor 3 controls at least some portion of the operation of the vehicle-based computing system. Provided within the vehicle, the processor allows onboard processing of commands and routines. Further, the processor is connected to both non-persistent 5 and persistent storage 7. In this illustrative embodiment, the non-persistent storage is random access memory (RAM) and the persistent storage is a hard disk drive (HDD) or flash memory.

The processor is also provided with a number of different inputs allowing the user to interface with the processor. In this illustrative embodiment, a microphone 29, an auxiliary input 25 (for input 33), a USB input 23, a GPS input 24 and a BLUETOOTH input 15 are all provided. An input selector 51 is also provided, to allow a user to swap between various inputs. Input to both the microphone and the auxiliary connector is converted from analog to digital by a converter 27 before being passed to the processor.

Outputs to the system can include, but are not limited to, a visual display 4 and a speaker 13 or stereo system output. The speaker is connected to an amplifier 11 and receives its signal from the processor 3 through a digital-to-analog converter 9. Output can also be made to a remote BLUETOOTH device such as PND 54 or a USB device such as vehicle navigation device 60 along the bi-directional data streams shown at 19 and 21 respectively.

In one illustrative embodiment, the system 1 uses the BLUETOOTH transceiver 15 to communicate 17 with a user's nomadic device 53 (e.g., cell phone, smart phone, PDA, etc.). The nomadic device can then be used to communicate 59 with a network 61 outside the vehicle 31 through, for example, communication 55 with a cellular tower 57.

Exemplary communication between the nomadic device and the BLUETOOTH Transceiver is represented by signal 14.

Pairing a nomadic device 53 and the BLUETOOTH transceiver 15 can be instructed through a button 52 or similar input, telling the CPU that the onboard BLUETOOTH transceiver will be paired with a BLUETOOTH transceiver in a nomadic device.

Data may be communicated between CPU 3 and network 61 utilizing, for example, a data-plan, data over voice, or DTMF tones associated with nomadic device 53. Alternatively, it may be desirable to include an onboard modem 63 in order to transfer data between CPU 3 and network 61 over the voice band. In one illustrative embodiment, the processor is provided with an operating system including an API to communicate with modem application software. The modem application software may access an embedded module or firmware on the BLUETOOTH transceiver to complete wireless communication with a remote BLUETOOTH transceiver (such as that found in a nomadic device). In another embodiment, nomadic device 53 includes a modem for voice band or broadband data communication. In the data-over-voice embodiment, a technique known as frequency division multiplexing may be implemented when the owner of the nomadic device can talk over the device while data is being transferred. At other times, when the owner is not using the device, the data transfer can use the whole bandwidth (300 Hz to 3.4 kHz in one example).

If the user has a data-plan associated with the nomadic device, it is possible that the data-plan allows for broad-band transmission and the system could use a much wider bandwidth (speeding up data transfer). In still another embodiment, nomadic device 53 is replaced with a cellular communication device (not shown) that is affixed to vehicle 31.

In one embodiment, incoming data can be passed through the nomadic device via a data-over-voice or data-plan, through the onboard BLUETOOTH transceiver and into the vehicle's internal processor 3. In the case of certain temporary data, for example, the data can be stored on the HDD or other storage media 7 until such time as the data is no longer needed.

Additional sources that may interface with the vehicle include a personal navigation device 54, having, for example, a USB connection 56 and/or an antenna 58; or a vehicle navigation device 60, having a USB 62 or other connection, an onboard GPS device 24, or remote navigation system (not shown) having connectivity to network 61.

Further, the CPU could be in communication with a variety of other auxiliary devices 65. These devices can be connected through a wireless 67 or wired 69 connection. Also, or alternatively, the CPU could be connected to a vehicle based wireless router 73, using for example a WiFi 71 transceiver. This could allow the CPU to connect to remote networks in range of the local router 73.

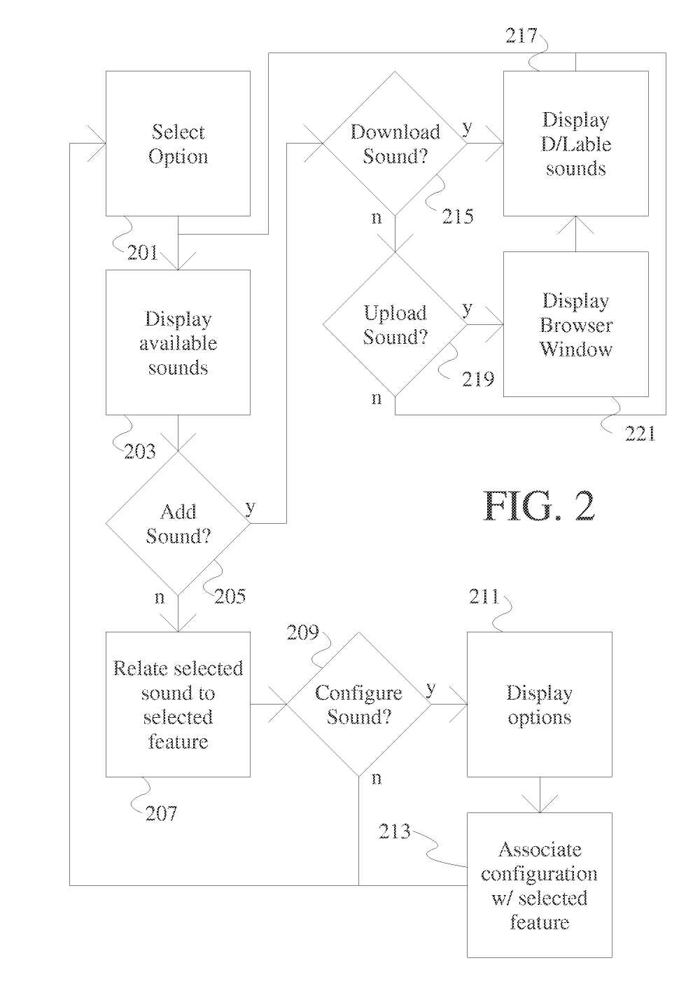

FIG. 2 is an illustrative process for acquiring and configuring vehicle system sounds. In this illustrative embodiment, a user logs into a configuration interface. The interface could be running as a local computer program on the user's PC, or it could be provided as, for example, a website. Accessing the configuration program would allow the user to select desired sounds for vehicle system events, and to create a fully customized audio schematic for the vehicle. Alternatively, a single event or system, such as, for example, the vehicle engine/shifting system could be focused on. Once the system is configured to the user's desired specifications, the configuration could be saved to, for example, a portable flash memory stick and then saved to the vehicle computing system. The configuration could also be uploaded to the computing system through a network connection, for example.

In this illustrative embodiment, after launching the configuration program, the user selects an option 201. This option could, for example, correspond to a vehicle system to which the user would desire to apply a chosen sound.

In one illustrative example, the user could choose to apply a classic vehicle engine sound to an actual engine in action. The user could, for example, select a classic FORD Mustang engine sound to apply to the engine of a FORD Taurus. Then, for example, when the FORD Taurus was driven, the vehicle computing system could apply the classic engine sounds through the audio system such that the driver had the feeling that the engine was that of the classic Mustang.

In another illustrative example, the user may choose a vehicle system that may or may not usually have a sound associated therewith. For example, the user could choose to apply a sound to a vehicle door opening. The sound doesn't need to be a “real” sound either. For example, a user could apply the sound of a door like one from STAR TREK to the opening of a vehicle door.

Or the user could apply a new sound to turning a vehicle light on. Sounds could be selected as a set (to be applied to a range of features) or for systems individually. This opens the way for expanded development of sounds specifically made with these purposes in mind.

Once the user has selected a system/feature to which to apply a sound, the system displays a list of available sounds 203. This could be a list of all sounds accessible by that user, or a list of sounds suited for/designed for a particular vehicle system/feature.

In this illustrative embodiment, the user is also provided with the option of adding a new sound 205. New sounds could be added from, for example, a personal library of sounds or downloadable from a website.

If the user wishes to add a sound, the user is given an option to download a sound 215. If the user wants to download a sound, a list of downloadable sounds is displayed 217. If the user wants to upload a sound 219, a browser window for selecting sounds from the user's PC may be shown 221. In either of these instances, the user can select a sound for addition to the system.

The system then relates the selected sound to the selected feature 207. In some illustrative embodiments, the sound may need to be configured for an option 209. The configuration could be for a range of the sounds, the volume of the sounds, a pitch, etc. A list of configuration options could be displayed 211 from which the user can select. Once the configuration has been set up, the configuration is associated with the selected feature and then the process repeats if the user wants to select another option.

One example of a configurable sound would be a sound for a window rolling down. Say, for example, the user wished to have the sound of a slide whistle play when the window went down. The user could configure the sound to play completely from whenever the window went through a full cycle or though any portion which the window is presently in (i.e., half down to all the way down).

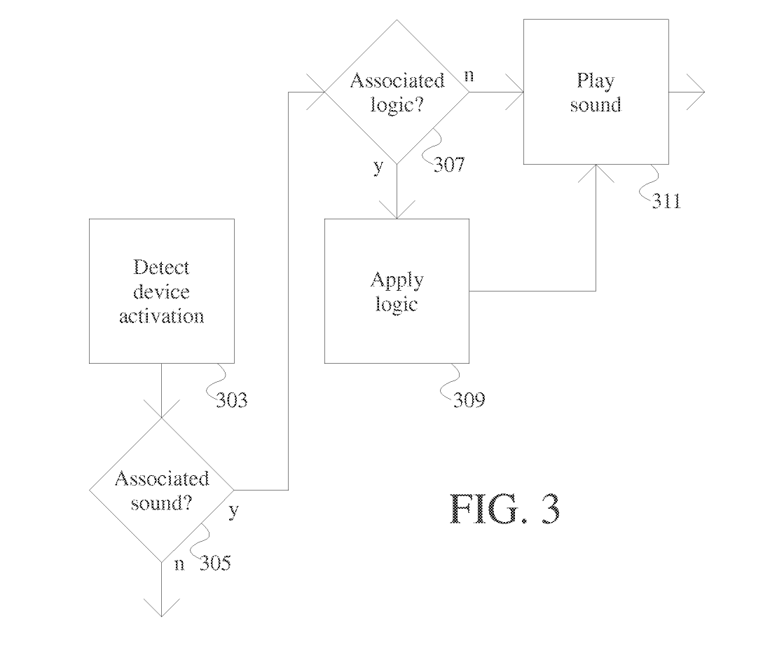

FIG. 3 is an exemplary process for applying a vehicle system sound to a vehicle system access. In this illustrative embodiment, the vehicle computing system detects the activation of a vehicle system/feature 303. In this illustrative embodiment, the vehicle computing system accesses the vehicle CAN bus. Many vehicle systems can provide information to the computing system in this manner. When the appropriate signal comes through the vehicle CAN bus, the computing system checks to see if there is a sound associated with the activated vehicle system/feature.

If there is a sound associated with the selected system/feature, the vehicle computing system checks to see if there is also logic associated with the sound 307. That is, the system checks if a static sound is to be played or if there is a variance to the sound depending on the present state of the activated device. If there is logic the computing system applies the logic 309. Then the system plays the sound 311.

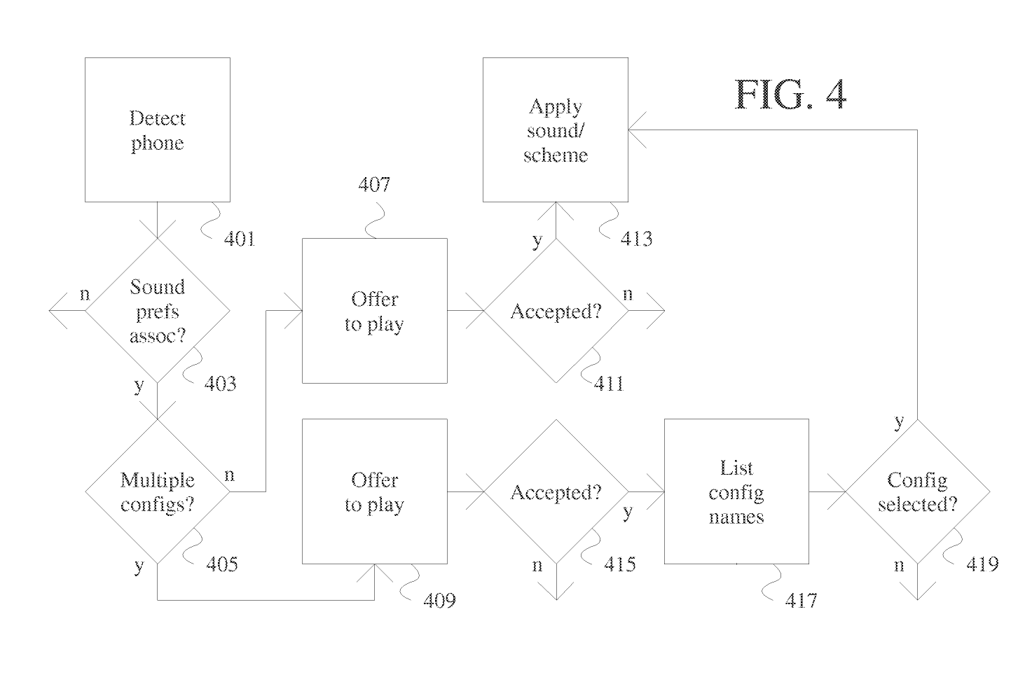

FIG. 4 is an exemplary process for automatically applying a vehicle sound configuration based on user device detection. In this illustrative embodiment, one or more sound configurations have been saved to the vehicle based computing system.

For example, a “cruising” configuration may have a certain engine and system sounds associated with it. A “techno” configuration may have different sounds associated with it. Both sound setups may be associated with a particular driver. A third “relaxing” configuration may be associated with a second driver.

The system detects a phone in proximity of the vehicle 401. Although not described in detail here, it may be the case that multiple phones having configurations associated therewith may be present in/near the vehicle. The system may prioritize the detected phones so that the configuration(s) associated with the higher priority phone are used.

Once a phone has been detected 401, the computing system checks to see if there is a sound preference associated with the detected phone 403. If there is a sound preference associated with the detected phone, the computing system checks to see if there are multiple configurations associated with the detected phone. If there is only one configuration, the computing system offers to play/enable the associated configuration 407.

In this illustrative embodiment, the user may not always wish to play the associated sound settings, so the user has the option not to have the sounds play. In another embodiment, the sounds may always play until deactivated or never play until activated. Any suitable configuration is acceptable.

If the user elects to apply the configuration 411, the computing system applies the sound scheme to the selected components 413 and then activates the appropriate sounds accordingly.

If there are multiple configurations associated with a device, the system again presents the user with the option to hear one of the configurations 409. If the user wishes to apply a configuration, the system will list the names of the available configurations 417. These could be user assigned names that describe the configurations, or names such as “configuration one” “configuration two” etc.

If no configuration is selected 419, the system assumes that the user does not want to play any of the available configurations and exits. Otherwise, the computing system applies the selected sound scheme 413.

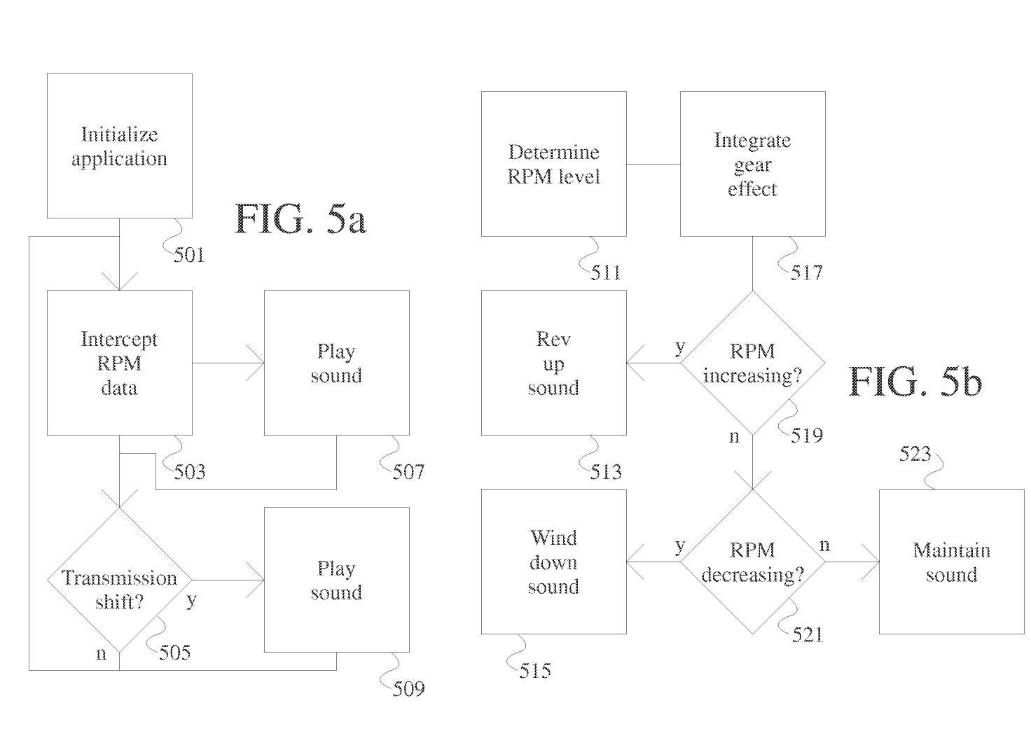

FIGS. 5a & 5b show an illustrative example of a process for applying a virtual engine sound to a vehicle engine.

In FIG. 5a, a vehicle computing system actives an application designed to apply a sound to an engine process to simulate the sounds of driving a vehicle with a different engine. This is just one possible application of the illustrative embodiments, and is shown not to limit the application but rather to provide at least one non-limiting example of how the illustrative embodiments may be used. In this illustrative embodiment, after the application has been initialized 501, the computing system intercepts RPM data from the vehicle's CAN bus 503. Once the RPMs of the engine have been determined, the vehicle computing system plays a sound associated with the present RPM level 507. This sound is played through a vehicle audio system, and is designed to simulate the engine sounds of a selected vehicle running at the present gear and at the present RPM level. The computing system also can detect a transmission shift 505 over the CAN bus. If there is a sound associated with the transmission shift, the computing system plays the sound over the vehicle audio system.

FIG. 5b shows one illustrative example of a process for playing the sounds associated with various RPM levels. Since a vehicle may sound different a different RPMs depending on what gear is engaged, a transmission effect may need to be applied. The sound may also increase or decrease in pitch as the vehicle engine revs up or winds down.

First, the RPM level is determined 511. Once the RPM level has been determined, any needed gear level effects are applied 517. (E.g., without limitation, changing the pitch of the sound based on a present gear).

If the vehicle RPMs are increasing 519, a sound associated with the engine revving up can be played 513. If the RPMs are decreasing 521, a sound associated with an engine winding down can be played 515. Finally, if the RPMs are constant (or within a predetermined “unchanged” threshold) the present virtual engine sound can be maintained.

What is claimed:

1. A method of vehicle system sound playback comprising:
uploading at least one user-selected sound to be associated with at least one vehicle system to a persistent memory within a vehicle;
associating the at least one sound with the at least one vehicle system based on a pre-selection made by the user;
detecting the activation of the at least one vehicle system; and
playing the at least one sound associated with the vehicle system through a vehicle audio system.

2. The method of claim 1, wherein the at least one user-selected sound is a user definable sound.

3. The method of claim 2, wherein the user definable sound has one or more variables associated therewith, based at least in part on the at least one vehicle system with which it is to be associated, and at least one of the variables has user definable options associated therewith.

4. The method of claim 3, further including:
uploading the one or more variables associated with the user definable sound;
wherein the detecting the activation further includes detecting a vehicle system event corresponding to at least one of the one or more variables; and
wherein the playing further includes adjusting the at least one sound based at least in part on the one or more variables corresponding to the detected vehicle system event.

5. The method of claim 4, wherein the event is a gear change.

6. The method of claim 4, wherein the event is an acceleration event.

7. The method of claim 4, wherein the event is a deceleration event.

8. The method of claim 1, wherein the vehicle system is a vehicle door.

9. The method of claim 1, wherein the vehicle system is a vehicle window.

10. A computer readable storage medium storing a plurality of instructions that, when executed, cause a vehicle based computing system to perform the steps comprising:
accessing a vehicle system bus to read signals passing therethrough;
detecting a signal indicating a change in a vehicle system state, wherein a user-definable sound has been pre-associated with the vehicle system and stored in a persistent memory within a vehicle;
playing the user-definable sound through an audio system of the vehicle.

11. The computer readable storage medium of claim 10, wherein the vehicle system bus is a CAN bus.

12. The computer readable storage medium of claim 10, wherein the vehicle system is a transmission system.

13. The computer readable storage medium of claim 12, wherein the change in the vehicle system state is a change of gears.

14. The computer readable storage medium of claim 10, wherein the change in state is an acceleration of the vehicle.

15. The computer readable storage medium of claim 10, wherein the change in state is a deceleration of the vehicle.

16. A method for masking an engine sound with a virtual sound, comprising:
uploading a user-selected engine sound to a persistent memory within a vehicle;
detecting at least an acceleration or deceleration of the vehicle; and
based at least in part on the detected acceleration or deceleration, playing back the user-selected engine sound over an audio system of the vehicle.

17. The method of claim 16, wherein the user-selected engine sound is a replication of an older model vehicle engine sound.

18. The method of claim 16, further including detecting the RPM of the engine, wherein the playing back includes playing back a portion of the sound corresponding to the detected RPM.

19. The method of claim 16, further including detecting the engaged transmission gear.

20. The method of claim 19, wherein the playing back further includes altering the user-selected engine sound based at least in part on the detected engaged transmission gear.
